(19) United States
(12) Patent Application Publication
(10) Pub. No.: US 2014/0268420 A1
(43) Pub. Date: Sep. 18, 2014

(54) MAGNETIC WRITE HEAD HAVING A WRITE POLE WITH A CONSTANT FLARE ANGLE AND MULTIPLE YOKE ANGLES

(71) Applicant: HGST NETHERLANDS B.V., Amsterdam (NL)

(72) Inventors: Yingjian Chen, Fremont, CA (US); Shiwen Huang, Fremont, CA (US); Terence T. L. Lam, Cupertino, CA (US); Mun H. Park, San Jose, CA (US); Kyusik Shin, Pleasanton, CA (US); Yi Zheng, San Ramon, CA (US); Yuming Zhou, Lakeville, MN (US)

(73) Assignee: HGST NETHERLANDS B.V., Amsterdam (NL)

(21) Appl. No.: 13/830,567

(22) Filed: Mar. 14, 2013

(51) Int. Cl. G11B 5/127; G11B 5/187

(52) U.S. Cl. CPC G11B 5/127; G11B 5/187
USPC 360/234.7; 29/603.07

(57) ABSTRACT

A magnetic write head having a write pole with a novel configuration improving write field strength and field gradient while also reducing adjacent track interference and far track interference. The write pole is configured with a pole tip portion that has a narrow track width, preferably 15-30 degrees and a main yoke portion with a larger flare angle of about 45 degrees. The write pole also has an intermediate portion located between the pole tip and main pole portions. The intermediate portion includes a first portion adjacent to the pole tip that has a flare angle greater than the flare angle of the main yoke and has a second portion with a flare angle less than the flare angle of the yoke.

### FIELD OF THE INVENTION

The present invention relates to magnetic data recording and more particularly to a magnetic write element having a write pole having a constant flare angle and multiple yoke angles for improved magnetic performance.

### BACKGROUND OF THE INVENTION

At the heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider into contact with the surface of the disk when the disk is not rotating, but when the disk rotates air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes at least one coil, a write pole and one or more return poles. When a current flows through the coil, a resulting magnetic field causes a magnetic flux to flow through the write pole, which results in a magnetic write field emitting from the tip of the write pole. This magnetic field is sufficiently strong that it locally magnetizes a portion of the adjacent magnetic disk, thereby recording a bit of data. The write field, then, travels through a magnetically soft under-layer of the magnetic medium to return to the return pole of the write head.

The magnetic write pole has a flared shape that helps to channel magnetic flux to the magnetic write pole. Current designs have a flare angle that is curved near the air bearing surface. As a result, any variation in the location of the air bearing surface relative to the write pole causes a large variation in write pole width and flare angle. In addition, current write poles have a yoke shape that has a constant angle relative to the air bearing surface. This constant yoke angle, which can be 45 to 60 degrees, causes a thinner side shield thickness as measured from the ABS.

### SUMMARY OF THE INVENTION

The present invention provides a magnetic write head that includes a magnetic write pole having pole tip portion extending to an air bearing surface and having a first flare angle relative to a plane that is perpendicular to the air bearing surface. The write pole also has a main yoke portion removed from the air bearing surface and having a second flare angle relative to the plane that is perpendicular to air bearing surface, the second angle being greater than the first flare angle. The write pole also has an intermediate portion located between the pole tip portion and the main yoke portion.

The novel shape of the write pole provides ample room for the side magnetic shields in the location of the write pole. This advantageously prevents magnetic saturation of the side shields, which in turn prevents near track and far track interference.

The novel shape of the write pole also ensures high write field strength and field gradient for optimal magnetic performance of the write head.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider illustrating the location of a magnetic head thereon;

FIG. 3 is a side cross sectional view of a magnetic head according to an embodiment of the invention;

FIG. 4 is an enlarged, ABS view of a portion of the magnetic head of FIG. 3 as seen from line 4-4 of FIG. 3;

FIG. 5 is a top down view of a write pole of the write head of FIG. 3, as seen from line 5-5 of FIG. 3; and

FIG. 6 is a top down view of a magnetic write pole of a write head in an intermediate stage of manufacture, illustrating a method of manufacturing a magnetic write head according to an embodiment of the invention.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system and the accompanying illustration of FIG. 1 are for representation purposes only. It should be apparent that disk storage systems may contain a large number of disks and actuators, and each actuator may support a number of sliders.

FIG. 3 shows a side, cross sectional view of magnetic head 300 according to a possible embodiment of the invention. The magnetic head 300 includes a read head 302 formed on a slider body substrate 304, and a write head 306 formed over the read head 302. The read head 302 and write head 306 may be separated by a non-magnetic spacer layer 308 such as alumina. The read head 302 can include a magnetoresistive sensor element 310 sandwiched between first and second magnetic shields 312, 314, all of which can be encased in a non-magnetic electrically insulating fill layer 316 such as alumina.

The write head 306 includes a magnetic write pole 318, a leading magnetic return pole 320, and may include a trailing return pole 322. The write pole 318 can be magnetically connected with a magnetic shaping layer 324 that helps to conduct magnetic flux to the write pole. The write pole 318 and shaping layer 324 can be magnetically connected with the return poles 320, 322 by magnetic back gap structures 326, 328. The write head 306 also includes a non-magnetic, electrically conductive write coil 330, which can be constructed of a material such as Cu and which is shown in cross section in FIG. 3. The write coil 330 can be embedded in one or more non-magnetic insulation layers 332 which can be a material such as alumina and/or hard baked photoresist.

When an electrical current flows through the write coil 330, a resulting magnetic field causes a magnetic flux to flow through the magnetic layers 320, 326, 324, 328, 318, 322. This causes a write field being emitted from the tip of the write pole 318 at the ABS, which can write a bit of data to an adjacent magnetic medium (not shown in FIG. 3). A magnetic trailing shield 334 can be provided adjacent to the trailing edge of the write pole 318 and can be connected with the trailing return pole 322 as shown in FIG. 3. The magnetic shield 334 is separated from the trailing edge of the write pole 318 by a non-magnetic trailing gap layer 335. This trailing magnetic shield 334 increases the field gradient of the write field being emitted from the write pole 318. This results in improved magnetic switching during writing of data.

FIG. 4 shows an enlarged ABS view of a portion of the magnetic head 300 of FIG. 3 as seen from line 4-4 of FIG. 3. FIG. 4 shows the tip of the write pole 318 as viewed from the ABS. As can be seen, the write pole 318 can be formed with beveled sides, such that the write pole 318 forms a trapezoidal shape, or may form a tri-angular shape at very narrow track-widths. The trailing magnetic shield 322 has side portions 322a that extend down adjacent to the sides of the write pole 318 so that the shield 322 can be a wrap-around shield that provide a side shield function as well as a trailing shield function. These side shield portions 322a are separated from the sides of the write pole 318 by non-magnetic side gap layers 402. The side shielding from the portions 322a helps to prevent adjacent track interference (ATI) as well as far track interference (FTI). In addition, the write pole 318 has a novel configuration that improves the capability of the side shield portions 322a to prevent such ATI and FTI.

FIG. 5 shows a top down view of the magnetic write pole 318 and side shield portions 322a, as viewed from line 5-5 of FIG. 3. In FIG. 5 it can be seen that the write pole 318 has a generally bell shaped configuration. This novel shape improves performance of the write head in several ways.

The write pole 318 includes a pole tip portion 502 that is located at the ABS. The write pole 318 also includes an intermediate portion 504 that includes a first intermediate portion 504a and a second intermediate portion 504b, with the first intermediate portion 504a being closer to the ABS and closer to the pole tip portion 502 than the second intermediate portion 504b. Beyond the intermediate portion 504 is a main yoke portion 506. Each of these portions of the magnetic write pole structure 318 will be discussed in greater detail herein below.

With continued reference to FIG. 5, the pole tip portion 502 has sides 508 that define a relatively small angle 510 with respect to a plane that is perpendicular to the air bearing surface ABS. The angle 510 is preferably less than 45 degrees and is more preferably 15-30 degrees. In addition, it should be pointed out that this angle 510 is substantially constant and well controlled throughout the length of the side 508 of the pole tip portion 502. This is made possible by a manufacturing method that will be discussed in greater detail herein below.

The pole tip portion 520 terminates at the starting point of the first intermediate portion 504a. The first intermediate portion 504a defines an angle 512 with respect to a plane perpendicular to the ABS, and the second intermediate portion 504b defines an angle 514 with respect to a plane this plane. The main yoke portion 506 has sides that define an angle 516 with respect to the plane perpendicular to the ABS.

The angle 512 of the first intermediate portion 504a is greater than the angle 516 of the main yoke portion 506, and the angle 514 of the second intermediate portion 504b is less than the angle of the main yoke portion 516. Preferably, the angle 512 of the first intermediate portion 504a is greater than 45 degrees and more preferably about 60 degrees. The angle 514 of the second intermediate portion 504b is preferably less than 45 degrees and more preferably about 35 degrees. The angle 516 of the main flare portion 506 is between the angles 512 and 514 (as mentioned above) and is more preferably about 45 degrees.

The write pole 318 having the above described angles provides several advantages over prior art write poles, which have only a single angle from the ABS through the back of the yoke. One advantage of the structure described above is that it prevents magnetic saturation of the side shields 322a. This advantageously prevents far track interference, by allowing the side shields 322a to function more efficiently. As can be seen in FIG. 5, if the pole tip portion 502 had the same angle as the main pole portion 506 (e.g. 45 degrees) this same angle would translate to each of the side shields 322a. The inner back edge of the side shield would be limited by this angle of the pole tip portion 502, which would greatly restrict its throat height thickness in this region near the write pole 318. By making the pole tip 502 have a smaller angle 512 in this region, the write pole 318 essentially steps back from the ABS more quickly in this region, allowing the side shields 322a to have a greater throat height in this region. The angle 512 of the first intermediate region 504a, further from the ABS, having an angle of about 60 degrees has a large benefit in improving adjacent track and far track interference, but has little effect to no effect on the performance of the write pole 312 with regard to write field strength or field gradient. On the other hand, the angle 510 of the pole tip region can be adjusted for optimal write field strength and field gradient, thereby greatly improving the performance of the write pole 318 and magnetic head 300 (FIG. 3) by optimizing the angle on each head configuration.

With reference now to FIG. 6, a method is described for manufacturing a magnetic write pole with a constant flare of the pole tip portion at the ABS. FIG. 6 shows a top down view-down view of a main magnetic pole 318 as patterned on a substrate before slicing and lapping. As those skilled in the art will appreciate, a magnetic write pole is formed on a substrate by a process that includes photolithographically patterning a mask to define the write pole 318.

There are a couple of possible methods for forming a write pole. One method involves depositing magnetic material full film. A mask, including a photolithographically patterned photoresist mask, is formed having a shape that defines a write pole. An ion milling can then be performed to remove portions of the magnetic material that are not protected by the mask.

Another method, often referred to as a damascene process, involves depositing or plating a fill material. A mask is then formed that has an opening that is configured to define a write pole shape. An ion milling, reactive ion etching, is then performed to remove portions of the fill layer that are exposed through the opening to form a trench that is configured in the shape of a write pole. A magnetic material is then deposited or plated into the trench, and a chemical mechanical polishing process can then be performed to remove portions of the deposited magnetic material that extend outside of the trench.

After either of the above processes have been performed to form a magnetic write pole structure such 318 as shown in FIG. 6 (and after further manufacturing steps have been performed to form other portions of the write pole) a slicing and a lapping operation are performed to remove material from the direction indicated by arrow 602. The lapping is performed until the intended air bearing surface location (designated by dashed line ABS) is reached.

As can be seen in FIG. 6, the magnetic write pole material 318 has a flared pole tip portion 604, a constant width trench portion 606, and a transition point 608 between the portions 604, 606. Prior art processes for manufacturing a magnetic write pole have located the transition point 608 at or near the ABS location. However, it will be recalled that whatever process is used to define the write pole 318, it involves the use of a photolithographically patterned photoresist mask. A photoresist mask cannot practically be constructed with perfectly sharp corners. Therefore, the actual shape of the transition point will not be a perfect sharp angle, but will actually be a curved or rounded transition. It will also be appreciated that the actual location of the air bearing surface (ABS) where lapping is terminated cannot be determined with perfect accuracy, because of various process variations and deviations. A rounded transition point located at the ABS will result in a large variation in flare angle immediately at the ABS as a result of variation in the ABS location. Therefore, prior art processes have resulted in large variations in flare angle at the ABS. Since the flare angle at the ABS has a large effect on write head performance, such variation is unacceptable.

The present invention overcomes this challenge. As can be seen in FIG. 6, the location of the transition point is not located at the ABS, but is some distance away from the ABS. Therefore, the necessary curvature at the transition point 608 is away from the ABS. This means that the angle of flare of the pole tip portion 604 remains constant even with significant variation in location of the ABS plane. In order to achieve this benefit, the distance between the transition point 608 and the intended ABS plane is preferably at least 50 nm. It will also be appreciated that, because the flare angle 510 of the pole tip portion 502 (FIG. 5) is much smaller than with prior art write poles, a given variation or deviation in actual ABS location will result in smaller variations in magnetic core width (width of the write pole at the air bearing surface (ABS).

It can also be appreciated with reference to FIG. 6, that the above described solution to flare angle control at the ABS is made possible by novel write pole shape described above with reference to FIG. 5. It will be recalled, that the novel bell shape of the write pole 318 allows the pole tip portion 604 in FIG. 6 (or 502 in FIG. 5) to have a much smaller flare angle 510 (FIG. 5). Prior art write poles had a flare angle at the ABS that was essentially the same as the flare angle in the back yoke region (e.g. 45 degrees). With this larger yoke angle, the transition point could not be moved away from the ABS, since doing so would mean completely eliminating the trench portion (e.g. running out of write pole material in the trench). With the smaller angle 510 (FIG. 5) of the pole tip portion, the transition point 608 (FIG. 6) can be removed from the ABS while still having remaining write pole material in the constant width trench portion 606.

While various embodiments have been described above, it should be understood that they have been presented by way of example only and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A magnetic write head, comprising:
a magnetic write pole having pole tip portion extending to an air bearing surface and having a first flare angle relative to a plane that is perpendicular to the air bearing surface; a main yoke portion removed from the air bearing surface and having a second flare angle relative to the plane that is perpendicular to the to the air bearing surface, the second angle being greater than the first flare angle; and an intermediate portion located between the pole tip portion and the main yoke portion.

2. The magnetic write head as in claim 1, wherein the first flare angle is less than 45 degrees.

3. The magnetic write head as in claim 1, wherein the first flare angle is 15-30 degrees.

4. The magnetic write head as in claim 1, wherein the second flare angle is about 45 degrees.

5. The magnetic write head as in claim 1, wherein:
the intermediate portion includes a first intermediate portion adjacent to the pole tip portion and second intermediate portion adjacent to the main yoke portion;
the first intermediate portion has a third flare angle relative to the plane that is perpendicular to the air bearing surface that is greater than the second angle; and
the second intermediate portion has a fourth flare angle relative to the plane that is perpendicular to the air bearing surface that is less than the second flare angle.

6. The magnetic write head as in claim 5, wherein the third flare angle is about 60 degrees and the fourth flare angle is about 35 degrees.

7. The magnetic write head as in claim 5, wherein the first flare angle is substantially all of the way to the air bearing surface.

8. The magnetic write head as in claim 1, wherein the magnetic write pole has a bell shape.

9. The magnetic write head as in claim 1, further comprising first and second magnetic side shields located at the air bearing surface and extending from opposite sides of the magnetic write pole, and wherein each of the first and second magnetic side shields is separated from the write pole by a non-magnetic side gap layer.

10. The magnetic write head as in claim 1, wherein the write pole has first and second laterally opposed sides and a trailing edge extending from between the first and second laterally opposed sides, the magnetic write head further comprising:
a wrap-around magnetic shield that includes a trailing shield portion that is separated from the trailing edge of the write pole by a non-magnetic trailing gap layer and first and second side shield portions that are each separated from one of the first and second sides of the write pole by a non-magnetic side gap layer.

11. A method for manufacturing a magnetic write head, comprising:
forming a magnetic write pole on a substrate, the magnetic write pole having a pole tip portion that extends beyond an intended air bearing surface plane and a constant width portion, and a transition between the pole tip portion and the constant width portion located away from the air bearing surface;
performing a slicing and a lapping operation to remove portions of the write pole and substrate until the intended air bearing surface plane has been reached, and wherein the slicing and lapping operations remove the constant width portion and the transition.

12. The method as in claim 11, wherein the transition between the constant width portion and the pole tip portion is located at least 50 nm from the air bearing surface.

13. The method as in claim 11, wherein the pole tip portion has a flare angle of less than 45 degrees relative to a plane that is perpendicular to the intended air bearing surface plane.

14. The method as in claim 11, wherein the pole tip portion has a flare angle of 15-30 degrees relative to a plane that is perpendicular to the intended air bearing surface plane.

15. The method as in claim 11, wherein the flare angle of the pole tip portion defines a first flare angle, the write pole further comprising:
a main yoke portion removed from the air bearing surface and having a second flare angle relative to the plane that is perpendicular to the air bearing surface, the second angle being greater than the first flare angle; and
an intermediate portion located between the pole tip portion and the main yoke portion.

16. The method as in claim 15, wherein the second flare angle is about 45 degrees.

17. The method as in claim 15, wherein:
the intermediate portion includes a first intermediate portion adjacent to the pole tip portion and second intermediate portion adjacent to the main yoke portion;
the first intermediate portion has a third flare angle relative to the plane that is perpendicular to the air bearing surface that is greater than the second angle; and
the second intermediate portion has a fourth flare angle relative to the plane that is perpendicular to the air bearing surface that is less than the second flare angle.

18. The method as in claim 17, wherein the third flare angle is about 60 degrees and the fourth flare angle is about 35 degrees.

19. The magnetic write head as in claim 11, wherein the flare angle of the pole tip portion is constant through the intended air bearing surface plane.

20. The method as in claim 11, wherein forming the magnetic write pole further comprises:
depositing a magnetic material;
forming a mask structure that is configured to define a write pole shape over the magnetic material; and
performing an ion milling to remove portions of the magnetic material that are not protected by the mask.

21. The method as in claim 11, wherein the forming the magnetic write pole further comprises:
depositing a fill material;
forming a mask structure over the fill material, the mask structure having an opening configured to define a write pole shape;
performing an ion milling or reactive ion etching to remove a portion of the fill material that is not protected by the mask to form a trench in the fill material; and
depositing a magnetic material into the trench.
